(19) United States
(12) Patent Application Publication
(10) Pub. No.: US 2015/0215998 A1
(43) Pub. Date: Jul. 30, 2015

(54) DEVICE AND METHOD FOR CONTROLLING AN ELECTRIC ARC FURNACE IN THE INITIAL PHASE OF A MELTING PROCESS

(71) Applicant: MASCHINENFABRIK REINHAUSEN, Regensburg (DE)

(72) Inventors: Klaus Krueger, Hamburg (DE); Dieter Dohnal, Lappersdorf (DE); Karsten Viereck, Regensburg (DE); Alexei Babizki, Regensburg (DE)

(21) Appl. No.: 14/428,691

(22) PCT Filed: Oct. 9, 2013
(86) PCT No.: PCT/EP2013/071043

§ 371 Date: Mar. 17, 2015

(30) Foreign Application Priority Data
Oct. 16, 2012 (DE) 10 2012 109 844.1

(51) Int. Cl. H05B 7/148; F27D 19/00

(52) U.S. Cl. CPC H05B 7/148; F27D 19/00; F27D 2019/0037

(57) ABSTRACT

Disclosed is a device and a method for regulating an electric arc furnace (10) in the initial phase of a smelting process. A sensor (16) for measuring the present voltage and a sensor (15) for measuring the presently flowing current are provided in each line (7) of the electric arc furnace (10). The actual impedance (Zᵢₛₜ) is time-dependently calculated by a control and regulating unit (30). An on-load tap changer (20) that is constructed as a semiconductor tap changer, is assigned to a furnace transformer (6) with a primary side (6P) and a secondary side (6S). The semiconductor tap changer (20) realizes a cycle time of a few milliseconds.

The invention relates to a device for regulating an electric arc furnace in the initial phase of a smelting process. For this purpose, the device in particular provides three lines, each with one electrode and one assigned phase conductor for energy supply. A sensor for measuring the present voltage and a sensor for measuring the presently flowing current are provided in each line. A time-dependent electrical actual value is calculated for each line by a control and regulating unit. Furthermore, at least one furnace transformer with a primary side and a secondary side is provided. An on-load tap changer switches the winding taps of the primary side, and the three electrodes are electrically connected with the secondary side of the at least one furnace transformer.

The invention further relates to a method for regulating an electric arc furnace in the initial phase of a smelting process.

The German patent specification DE 35 12 189 [U.S. Pat. No. 4,683,577] discloses a method and a device for regulating electric arc furnaces. The purpose is to enable precision adjustment of the electric arc voltage and the electrode height in a manner that is economical and technically feasible without great effort. The actuator for transformer voltage is always controlled by a current regulation loop that a power regulation loop is superimposed on in the instance of a power regulation. The power regulator superimposed on the current regulator then provides the reference variable for the current regulator. In all cases, only the arc voltage regulator acts directly on the electrode adjustment. For the tap changer drive used for the transformer, this therefore results in the possibility to either feed the transformer voltage directly via a set-point specification or to adjust it via the tap changer by the mentioned current regulator that is superimposed by a power regulator, as the case may be. The lift drive is actuated via a current regulator, with the respective control voltage being supplied either from a current regulator or from a wear regulator or directly as a specified target value.

The European patent application EP 2 362 710 [US 2012/0320942] discloses an electric arc furnace and a method for operating an electric arc furnace. The electric arc assigned to the at least one electrode has a first radiant power that results on the basis of a first adjusted set of operating parameters. The electric arc furnace is operated according to a specified operation program that is based on an expected process sequence. Monitoring is conducted as to whether there is an undesired deviation between the actual process sequence and the expected process sequence. If there is a deviation, a modified second radiant power is specified. By means of the second radiant power, a modified second set of operating parameters is determined. The method allows to achieve an as short as possible smelting duration while protecting the operating means, in particular the electric arc furnace cooling system.

The German patent application DE 35 43 773 [U.S. Pat. No. 4,689,800] describes a method for operating an electric arc furnace such that it is possible with fluctuating raw materials to smelt this material at a minimum value of the drawn electrical energy consumption. The furnace transformer is provided with a load switch, thus making it possible to adjust the output voltage at the secondary side of the transformer. The control is carried out by modifying the taps of the furnace transformer or by lifting and lowering the arc electrodes by an electrode lifting device of the electric arc furnace in order to change the length of the electric arc. At the same time, the electric current flowing from the secondary side of the furnace transformer to the arc electrode is measured. If the electric arc furnace is operated with an electric current that is controlled in this manner, then the electrical energy consumption is lowered in the smelting process and the drawn electrical energy consumption can be kept at a minimum.

The German patent application DE 10 2009 017 196 [U.S. Pat. No. 8,624,565] discloses a tap changer with semiconductor switching components for uninterrupted switching between fixed tap changer contacts that are electrically connected with winding taps of a tapped transformer. In this context, each of the fixed tap changer contacts is either directly connectable with a load dissipation or, during switch over, connectable via the interconnected semiconductor switching components. The load dissipation has fixed, divided dissipation contact pieces so that the semiconductor switching components are galvanically isolated from the transformer winding during stationary operation. There are, however, various disadvantages to tap changers with semiconductor switching components. The permanent application of operating voltage and the strain on the power electronics by lightning impulse voltage necessitate large isolation distances, which are not desirable.

As known from the prior art, the electrical components for controlling or regulating the operation of an electric arc furnace are a furnace transformer, a choke coil, and an electrode support arm system. The energy supply for the alternating current electric arc furnaces is carried out via furnace transformers with an integrated tap changer. The corresponding energy input can be adjusted by the transformer stages.

A choke coil that is switchable under load and connected upstream of the transformer, serves for regulating the reactance of the current circuit and thus enables operating the furnace with stable electric arcs as well as limiting the short circuit current. The suitable stage is selected both for the transformer and for the series-connected choke in dependence on process progress. This can be effected by manual intervention from the furnace operator, by an integrated control, or by regulation.

In manual control, an experienced furnace operator can assess the present energy input by the color of the furnace chamber and by its contents. This is a possibility for subjective observation of the furnace state and the smelting process. The transformer stage is adjusted in critical situations (for instance, damage to the refractory).

In automatic control, the transformer stages and the choke stages, as the case may be, are adapted depending on the present energy input. In order to maintain the electric arc as stable as possible, a high inductance is generally required in the initial “drilling phase” (OLTC choke==highest stage). The series-connected choke is switched off in the last phase “liquid bath” in order to reduce the reactive power.

A lower voltage step (short electric arcs) is selected during the drilling phase to protect the refractory lining of the furnace (the refractory) as well as the furnace lid. After the electric arc has been covered in foaming slag, the highest voltage step is selected to achieve the highest energy input into the melt. To ensure the high energy input during the final phase, a slightly lower step voltage is selected, while using the maximum current setting.

In particular in the manual and automatic control processes, the above mentioned specifications only very inadequately measure up to the actual process state. Even the newest regulations are also not able to react with the appropriate time constants (e.g. in the range of milliseconds) to the quick changes in the system.

With regard to tap changers in furnace transformers and choke coils and depending on the diverse switching strategies of the customers, the high switching frequencies are regarded as a technical stress factor. This is primarily attributed to contact erosion and to wear of the mechanical components in the tap changers.

Maintenance works on tap changers normally imply a high effort and, above all, cost-intensive production downtime, making it definitely desirable for the operator to extend the maintenance interval in order to reduce the maintenance effort for the tap changer as much as possible.

The object of the invention is to create a device for regulating an electric arc furnace in the initial phase of a smelting process, which device enables a quick voltage adjustment to prevent an event of over current.

The object is solved by a device for regulating an electric arc furnace in the initial phase of a smelting process comprising the features of claim 1.

It is a further object of the invention to create a method for regulating an electric arc furnace in the initial phase of a smelting process, which method enables a quick voltage adjustment to prevent an event of over current.

The object is solved by a method for regulating an electric arc furnace in the initial phase of a smelting process comprising the features of claim 3.

The device according to the invention for regulating an electric arc furnace in the initial phase of a smelting process is characterized in that the on-load tap changer is a semiconductor tap changer that enables a cycle time of a few milliseconds. In particular in the initial phase of the smelting process, the collapsing of the scrap heap can lead to short circuits around the electrodes, thus causing over currents. The objective is to prevent these over currents by a continuously adjusting supply of the electrodes with electrical energy or to reduce them to such an extent that no damages are caused to the electric arc furnace or to the refractory.

According to one embodiment, the control and regulating unit comprises a regulation algorithm, by means of which a target position of the semiconductor tap changer is calculable. The target position of the semiconductor tap changer enables setting a current limit value, with the respective current limit value being calculable in dependence on the measurements of the sensors of each line and the respectively resulting electrical actual values. By means of the semiconductor tap changer, it is then possible to switch to a target position corresponding to a target winding tap.

The method according to the invention is characterized in that:

a current measurement and a voltage measurement for each of the three lines of a secondary side of a furnace transformer are carried out;

a suitable target phase voltage and a respectively assigned target winding tap of a primary side of the furnace transformer are calculated with a regulation algorithm and based on the operating parameters specified in a control and regulating unit so that a current upper limit is adhered to; and

in that the adjustment of the target winding tap that is to be adjusted and that is on the primary side of the furnace transformer, is carried out symmetrically for all lines of the electric arc furnace and the semiconductor tap changer switches to the corresponding target position.

The specified operating parameters of an electric arc furnace are understood to mean the electrical quantities, such as for instance voltage, current, and impedance in the lines, and also the switching of the winding taps of the furnace transformer during start-up of the electric arc furnace.

The electrical actual value is calculated by selecting the appropriate line from among the lines that has an extreme value for the electrical actual value. Then a comparison is conducted, whether the extreme value for the electrical actual value is below a limit value for the electrical actual value. The electrical actual value can be an impedance or an admittance. Further characterizing electrical actual values are conceivable. The use of impedance or admittance is not intended as a limitation of the invention.

Usually, a cycle time for determining the target position of the semiconductor tap changer and the corresponding switching to the target winding tap at the furnace transformer is in the range of 20 milliseconds.

For determining the electrical values, a low-pass filtering that is adjusted to a control dynamic is carried out. The adjustment of the phase voltages on the secondary side of the furnace transformer can also be carried out asymmetrically.

In the case of the electrical actual value being the impedance, the impedance limit value is removed by the semiconductor tap changer that switches to the smallest possible winding tap of the primary side of the furnace transformer. In this way, the voltage on the secondary side of the furnace transformer is reduced. Reducing the voltage on the secondary side of the furnace transformer is conducted specifically in each individual line.

These and other features and advantages of the various disclosed embodiments set forth here will be more fully understood with reference to the following description and the drawings, throughout which the same reference characters designate the same elements, and in which:

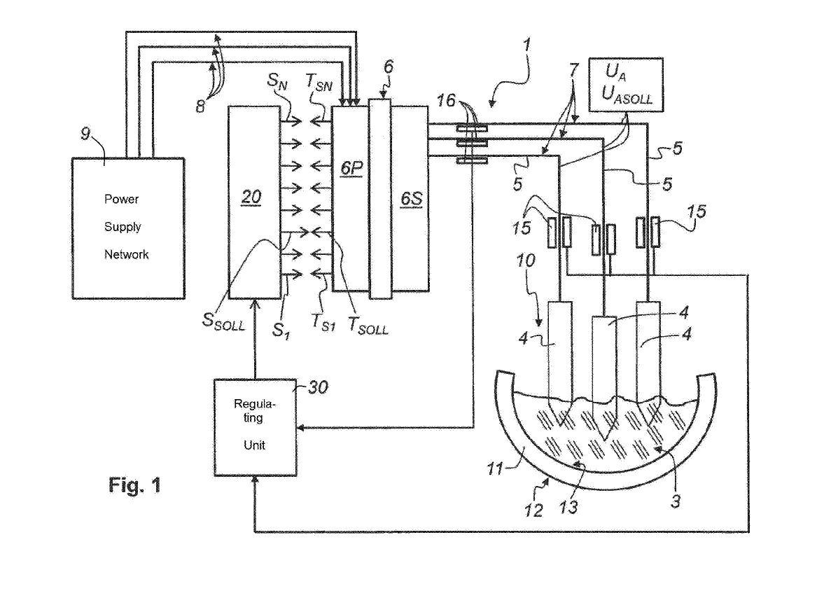

FIG. 1 shows a schematic presentation of a system for smelting metal by an electric arc furnace;

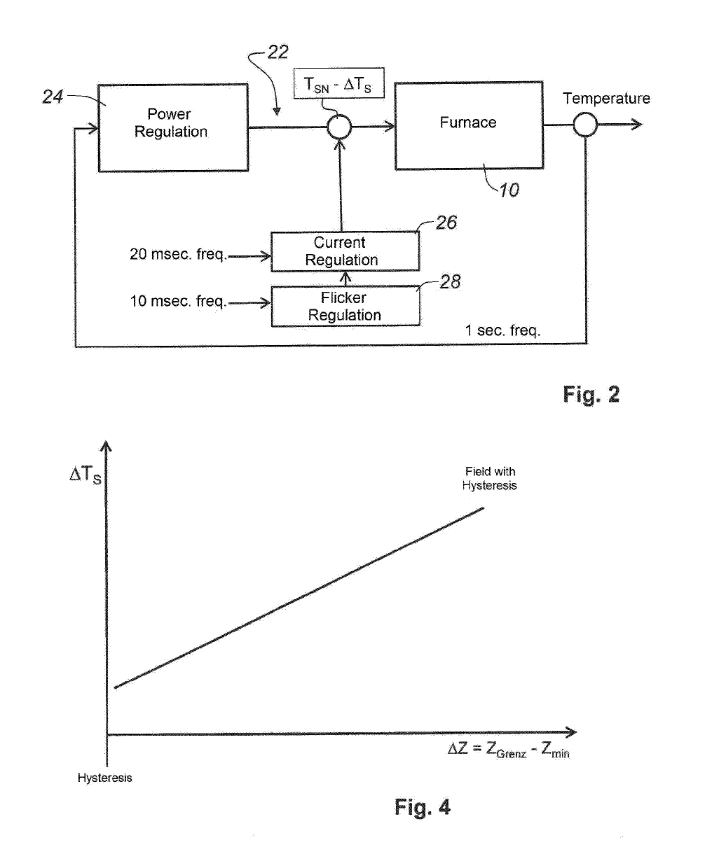

FIG. 2 renders a schematic presentation of the integration of the regulation of an electric arc furnace in the initial phase of the smelting process into the overall regulation of the electric arc furnace;

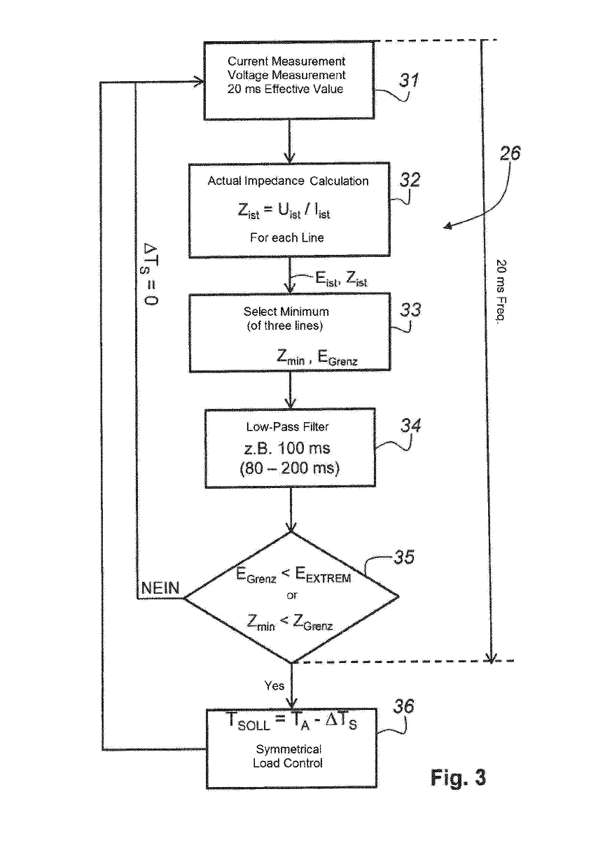

FIG. 3 gives a schematic view of the flowchart of the regulation of an electric arc furnace in the initial phase of the smelting process; and

FIG. 4 shows a graphic chart of the difference of the winding taps in relation to the difference of the determined impedance.

FIG. 1 shows a schematic presentation of a system 1 for smelting metal by an electric arc furnace 10. The electric arc furnace 10 is composed of a furnace vessel 11, in which steel scrap is smelted, from which a melt 3 is produced. The furnace vessel 11 is additionally provided with a lid that is not illustrated. The wall 12 and lid are provided with a water cooling system. In dependence on the operating mode of the electric arc furnace 10, the furnace has one or three electrodes 4. One electrode 4 is used in a direct current electric arc furnace. Three electrodes 4 are used in an alternating current electric arc furnace 10. The following description illustrates the principle of the invention as exemplified by an alternating current electric arc furnace. A refractory material that is not illustrated lines an inner wall 13 of the electric arc furnace 10.

The electrodes 4 are arranged on a support arm, which is not illustrated, and they can be inserted into the furnace vessel 11 as required. Each of the electrodes 4 is equipped with a phase conductor 5 that is connected with a secondary side 6S of a furnace transformer 6. The phase conductor 5 and the electrode 4 thus form a phase or a line 7 of the alternating current circuit. A primary side 6P of the furnace transformer 6 is supplied with the required high voltage from a power supply network 9. An on-load tap changer 20, which is constructed as a semiconductor tap changer, is connected with the primary side 6P of the furnace transformer 6.

A control and regulating unit 30 co-acts with the semiconductor tap changer 20 to switch winding taps T_{S1} . . . T_{SN} of the furnace transformer 6 on the primary side 6P in such a manner that the winding taps are supplied with a corresponding voltage and a corresponding current such that a predetermined electrical actual value Eᵢₛₜ prevails in the lines 7. The electrical actual value Eᵢₛₜ can be an impedance Z or an admittance Y, for instance. The primary side 6P of the furnace transformer 6 has a plurality of winding taps T_{S1} . . . T_{SN} that are switched by the semiconductor switching components S₁ . . . S_{N} of the semiconductor tap changer 20. The control and regulating unit 30 receives input from current sensors 15 and voltage sensors 16 that are assigned to the lines 7 of the electric arc furnace 10. From the input data, the control and regulating unit 30 determines the switching sequence of the semiconductor tap changer 20 and the required switching of the winding taps T_{S1} . . . T_{SN} of the primary side 6A of the furnace transformer 6 such that the current in the lines 7 or, as the case may be, in one specific line 7, is limited. The current sensors 15 and the voltage sensors 16 can also be provided in supply lines 8 to the primary side 6P of the furnace transformer 6.

Strong fluctuations of the current or of the voltage occur during the initial phase of the smelting process in the electric arc furnace 10. Short circuits and significantly excessive currents in general are frequently the result. This is due to locally collapsing scrap heaps. This situation can be significantly mitigated by the fast semiconductor tap changer 10 according to the invention. In the most extreme case, the semiconductor tap changer 10 switches to the smallest possible winding tap T_{S1} (or transformer stage, respectively) so that this results in the lowest voltage of the furnace transformer 6. This procedure can also be carried out asymmetrically, i.e. specifically for each line 7. The semiconductor tap changer 20 furthermore offers the possibility of switching directly to the smallest possible winding tap T_{S1}, without having to switch through the sequence of intermediate winding taps.

Implemented into the control and regulating unit 30 is a regulation algorithm that calculates a target position S_{SOLL} of the semiconductor tap changer 20. It is thus possible to set a current limit value I_{Grenz}, wherein the respective current limit value I_{Grenz} of the semiconductor tap changer 20 is calculable in dependence on the measurements of the sensors 15, 16 of each line 7 and the respectively resulting electrical actual values Eᵢₛₜ. By means of the semiconductor tap changer 20, a target position S_{SOLL} that corresponds to a target winding tap T_{SOLL}, is switched to.

FIG. 2 renders a schematic presentation of the integration of a regulation of an electric arc furnace 10 in the initial phase of a smelting process into the overall regulation 22 of the electric arc furnace 10. The overall regulation 22 of the electric arc furnace 10 is ultimately realized via the semiconductor tap changer 20. The thermally based power regulation 24 works at a frequency in the range of 1 second. The over current regulation 26 works at a frequency in the range of 20 milliseconds. The flicker regulation 28 works at a frequency in the range of 10 milliseconds. The frequency for each of the regulations corresponds to the repetition rate of the corresponding regulations. As a result of the measurements, it is possible by means of the semiconductor tap changer 20 to switch over to the appropriate winding tap T_{S1} . . . T_{SN} on a primary side 6P of the furnace transformer 6 for carrying out the required regulation of the electric arc furnace 10 in such a manner that over currents are minimized or shut down. With regard to the occurring over current, the regulation of the power of the electric arc furnace 10 can be carried out symmetrically or asymmetrically by the semiconductor switch 20. An asymmetrical regulation of the electric arc furnace 10 in the initial phase of a smelting process is understood to mean a non-coupled modification of the regulated voltages at the phase conductors 5. As already mentioned, the frequency in this context is in a range of 20 milliseconds.

FIG. 3 illustrates a schematic view of a flowchart of the regulation of an electric arc furnace 6 in the initial phase of the smelting process. This regulation is an over current regulation 26, by which it is possible to react to the quick current changes in the initial phase of the smelting process. The following description deals with the impedance Z as electrical quantity. This is by no means intended as a limitation of the invention. As illustrated in FIG. 4, it is not intended to react to each current change by switching the winding taps T_{S1} . . . T_{SN} by the semiconductor tap changer 20. Intervention by the semiconductor tap changer 20 is required if a measured impedance Zᵢₛₜ is below an impedance limit value Z_{Grenz} for a specific time interval. The over current is is removed by the semiconductor tap changer 20 switching to the smallest possible winding tap T_{S1} or to T_{SOLL}.

In the procedure presented in FIG. 3, a current measurement and a line voltage measurement are carried out and the present current Iᵢₛₜ and the present voltage Uᵢₛₜ are determined in a first step 31. For this purpose, corresponding current sensors and voltage sensors 15 and 16 are provided in each line 7, as shown in FIG. 1. In a second step 32, a present impedance Zᵢₛₜ is calculated for each line 7. The appropriate line that has the lowest impedance Zₘᵢₙ is selected from the lines 7 in a third step 33. A low-pass filtering 34 of the values of the lowest impedance Zₘᵢₙ is conducted for all lines 7 in order to determine the line 7 with the lowest impedance Zₘᵢₙ. In a comparison step 35, it is checked whether the lowest impedance Zₘᵢₙ is below the impedance limit value Z_{Grenz}.

In a final step 36, it is now possible to calculate the highest current or, respectively, the lowest impedance Zₘᵢₙ. By means of a characteristics regulator, it is possible to calculate the required difference of the winding tap ΔTₛ that depends on the limit impedance Z_{Grenz} and the measured minimum impedance Zₘᵢₙ. This Tₛ is subtracted from the presently active winding tap T_{A} (transformer stage). A stage Tₛ to be adjusted on the primary side 6P of the furnace transformer 6 results from the difference between a presently active winding tap T_{A} on the primary side 6P of the furnace transformer 6 and the difference of the winding taps DT, on the primary side 6P of the furnace transformer 6. By means of the semiconductor tap changer 20, power regulation of the furnace transformer 6 to the winding tap Tₛ to be adjusted on the primary side 6P is carried out symmetrically for all lines 7 of the electric arc furnace 10. The frequency in this context is in the range of 20 milliseconds.

The present impedance Zᵢₛₜ is brought below the impedance limit value Z_{Grenz} by the semiconductor tap changer 20 switching to the smallest possible winding tap of the primary side 6P of the furnace transformer 6. The voltage on the secondary side 6S of the furnace transformer 6 is thus reduced. Reducing the voltage on the secondary side 6S of the furnace transformer 6 can be carried out specifically in each individual line 7.

The invention was described with reference to two embodiments. Those skilled in the art will appreciate that changes and modifications of the invention can be made without departing from the scope of protection of the following claims.

LIST OF REFERENCE CHARACTERS

| No. | Name |
|---|---|
| 1 | Device |
| 3 | Melt |
| 4 | Electrode |
| 5 | Phase conductor |
| 6 | Furnace transformer |
| 6P | Primary side |
| 6S | Secondary side |
| 7 | Line, phase |
| 8 | Supply lines |
| 9 | Power supply network |
| 10 | Electric arc furnace |
| 11 | Furnace vessel |
| 12 | Outer wall |
| 13 | Inner wall |
| 15 | Current sensor |
| 16 | Voltage sensor |
| 20 | On-load tap changer, |
| | semiconductor tap changer |
| 22 | Overall regulation |
| 24 | Thermally based power |
| | regulation |
| 26 | Over current regulation |
| 28 | Flicker regulation |
| 30 | Control and regulating unit |
| 31 | First step |
| 32 | Second step |
| 33 | Third step |
| 34 | Low-pass filtering |
| 35 | Comparison step |
| 36 | Final step |
| T_{S1} . . . T_{SN} | Winding tap, |
| | transformer stage |
| T_{A} | Presently active winding tap |
| T_{SOLL} | Target winding tap |
| DT_{S} | Difference of the winding |
| | taps |
| S₁ . . . S_{N} | Semiconductor switching |
| | component |
| S_{SOLL} | Target position |
| Eᵢₛₜ | Electrical actual value |
| E_{EXTREM} | Extreme value of the |
| | electrical actual value |
| E_{Grenz} | Limit value of the |
| | electrical actual value |
| I_{MAX} | Current upper limit |
| I_{Grenz} | Current limit value |
| U_{ASOLL} | Target phase voltage |
| Y | Admittance |
| Z | Impedance |
| Z_{Grenz} | Impedance limit value |
| Z_{Min} | Minimal impedance |
| Zᵢₛₜ | Presently active impedance |

1. A device for regulating an electric arc furnace in the initial phase of a smelting process, the device comprising:
three lines one electrode and a respective phase conductor for electrical energy supply;
a respective sensor for measuring the voltage and a sensor for measuring the current in each line;
a control and regulating unit for calculating an electrical actual value with respect to time for each line;
at least one furnace transformer with a primary side and a secondary side; and
at least one semiconductor on-load tap changer that switches winding taps of the primary side, the three electrodes being electrically connected with the secondary side of the at least one furnace transformer the on-load tap changer having a cycle time of a few milliseconds.

2. The device according to claim 1 wherein the control and regulating unit comprises a regulation algorithm, with which a target position of the semiconductor tap changer is calculable, by means of which target position a current limit value is adjustable, wherein the respective current limit value is calculable in dependence on the measurements of the sensors of each line and the respectively resulting electrical actual values such that it is possible to switch to a target position that corresponds to a target winding tap, by means of the semiconductor tap changer 20.

3. A method for regulating an electric arc furnace in the initial phase of a smelting process, the method comprising the steps of:
effecting a current measurement and a line voltage measurement for each of the three lines of a secondary side of a furnace transformer;
calculating a suitable target phase voltage and a respectively assigned target winding tap of a primary side of the furnace transformer with a regulation algorithm and based on the operating parameters specified in a control and regulating unit so that a current upper limit is adhered to; and
effecting the adjustment of the target winding tap that is to be adjusted and that is on the primary side of the furnace transformer symmetrically for all lines of the electric arc furnace; and
switching the semiconductor tap changer to the corresponding target position.

4. The method according to claim 3, further comprising the steps of:
calculating the electrical actual value for each line;
selecting the appropriate line from among the lines that has an extreme value for the electrical actual value; and subsequently
conducting a comparison whether the extreme value of the electrical actual value is below a limit value for the electrical actual value.

5. The method according to claim 3, wherein the electrical actual value is an impedance or an admittance.

6. The method according to claim 3, wherein a cycle time for determining the target position of the semiconductor tap changer and the corresponding switching to the target winding tap at the furnace transformer is in the range of 20 milliseconds.

7. The method according to claim 3, further comprising the step of:
carrying out a low-pass filtering that is adjusted to a control dynamic for determining the electrical values.

8. The method according to claim 3, further comprising the step of:
carrying out the adjustment of the phase voltages on the secondary side of the furnace transformer asymmetrically.
